(19) United States
(12) Patent Application Publication
(10) Pub. No.: US 2026/0192518 A1
(43) Pub. Date: Jul. 9, 2026

(54) TIMING BELT TENSIONER FOR 3D PRINTER, 3D PRINTER, AND 3D PRINTING SYSTEM

(71) Applicant: SHENZHEN TUOZHU TECHNOLOGY CO., LTD., Shenzhen (CN)

(72) Inventor: Qun DONG, Shenzhen (CN)

(73) Assignee: SHENZHEN TUOZHU TECHNOLOGY CO., LTD., Shenzhen (CN)

(21) Appl. No.: 19/553,464

(22) Filed: Mar. 2, 2026

Related U.S. Application Data
(63) Continuation of application No. PCT/CN2024/104540, filed on Jul. 9, 2024.

(30) Foreign Application Priority Data
Aug. 28, 2023 (CN) 202322325515.6

(51) Int. Cl. B29C 64/227; B33Y 30/00

(52) U.S. Cl. CPC B29C 64/227; B33Y 30/00

(57) ABSTRACT

The present application provides a timing belt tensioner for a 3D printer, the 3D printer, and a 3D printing system. The timing belt tensioner comprises a frame, a tensioning block, and only two rotating members, wherein the two rotating members comprise a first rotating member and a second rotating member; the first rotating member and the second rotating member are connected through a timing belt; one end of the tensioning block is connected to the frame, and the other end of the tensioning block is rotatable about the end connected to the frame; at a position between the end connected to the frame and the other end, the tensioning block is further connected to a rotating shaft of the first rotating member.

### CROSS-REFERENCES TO RELATED APPLICATIONS

The present application is a continuation of International Patent Application No. PCT/CN2024/104540, filed on July 9, 2024, which claims priority to Chinese Patent Application No. 202322325515.6, filed with the China National Intellectual Property Administration on August 28, 2023 and entitled “TIMING BELT TENSIONER FOR 3D PRINTER, 3D PRINTER, AND 3D PRINTING SYSTEM”, which is incorporated herein by reference in its entirety.

### FIELD

The present application relates to the field of 3D printing, and in particular, to a timing belt tensioner for a 3D printer, a 3D printer, and a 3D printing system.

### BACKGROUND

In the process of 3D printing, it is required that a motor drag a sliding block by a timing belt to achieve printing in all directions. That is, the tensioning degree of the timing belt affects the printing efficiency of the printer. In addition, due to its flexibility, the timing belt may become loose when used for a period of time, which may further affect the movement of the sliding block.

In order to solve the problem of the slack of the timing belt, the timing belt may be tensioned by mounting a tensioning wheel. As shown in FIG. 1, the timing belt may be tightened by adjusting the position of the tensioning wheel.

Although this method can achieve timing belt tensioning, it is necessary to reserve a certain space for the tensioning wheel, which will increase the space occupied by timing belt tensioning.

### SUMMARY

The present application provides a timing belt tensioner for a 3D printer, a 3D printer, and a 3D printing system, which can reduce the occupied space required for timing belt tensioning and feature good compactness.

An embodiment of the present application provide a timing belt tensioner for a 3D printer. The timing belt tensioner includes a frame, a tensioning block and only two rotating members, wherein the two rotating members comprise a first rotating member and a second rotating member;

the first rotating member and the second rotating member are connected through a timing belt;

one end of the tensioning block is connected to the frame, and the other end of the tensioning block is rotatable about the end connected to the frame;

at a position between the end connected to the frame and the other end, the tensioning block is further connected to a rotating shaft of the first rotating member.

In a second aspect, the embodiments of the present application further provide a 3D printer, where the 3D printer includes a timing belt and the timing belt tensioner as described with reference to the first aspect or with reference to any one of the foregoing possible implementations of the first aspect.

In a third aspect, the embodiments of the present application further provide a 3D printing system, which includes a feeding device and the 3D printer as described with reference to the first aspect or with reference to any one of the foregoing possible implementations of the second aspect, where the feeding device is connected to the 3D printer.

It should be understood that for implementation and beneficial effects of the foregoing aspects of the present application, reference may be made to each other.

### BRIEF DESCRIPTION OF THE DRAWINGS

FIG. 1 is a schematic diagram of a tensioning wheel of a 3D printer system in the prior art;

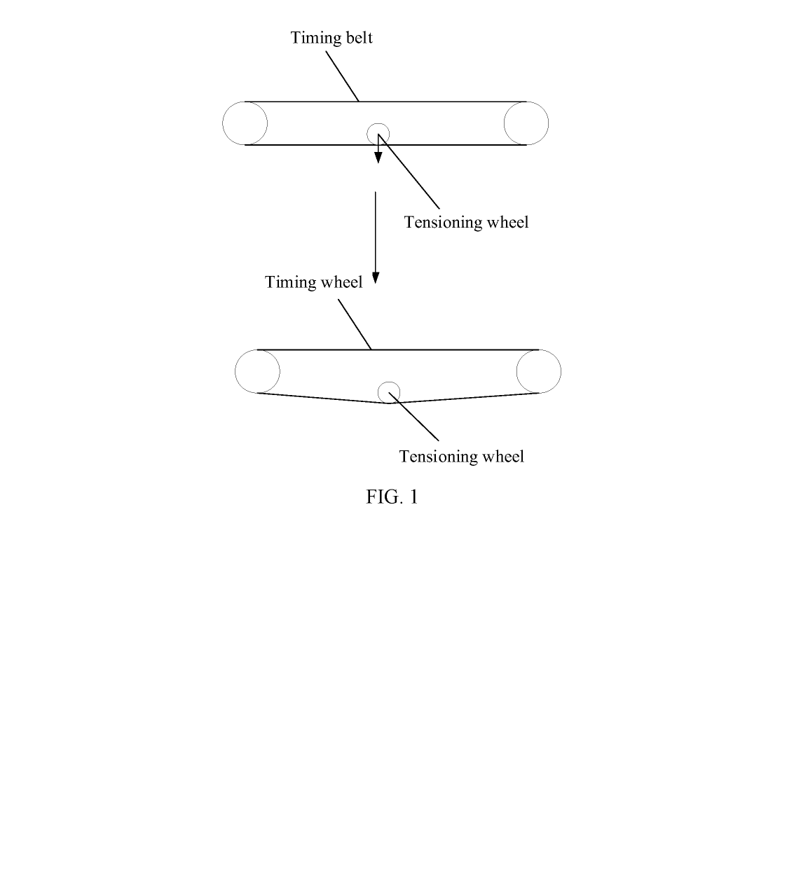

FIG. 2 is a schematic diagram of a scenario of a 3D printing system according to an embodiment of the present application;

FIG. 3a is a schematic diagram of a planar structure of a timing belt tensioner according to an embodiment of the present application;

FIG. 3b is another schematic diagram of a planar structure of a timing belt tensioner according to an embodiment of the present application;

FIG. 4 is another schematic diagram of a planar structure of a timing belt tensioner according to an embodiment of the present application;

FIG. 5 is another schematic diagram of a planar structure of a timing belt tensioner according to an embodiment of the present application;

FIG. 6a is a schematic diagram of a planar structure illustrating part of the structure of a timing belt tensioner according to an embodiment of the present application;

FIG. 6b is another schematic diagram of a planar structure illustrating part of the structure of a timing belt tensioner according to an embodiment of the present application;

FIG. 6c is another schematic diagram of a planar structure illustrating part of the structure of a timing belt tensioner according to an embodiment of the present application;

FIG. 7a is a schematic diagram of a three-dimensional structure of a timing belt tensioner according to an embodiment of the present application;

FIG. 7b is a front view of a timing belt tensioner according to an embodiment of the present application;

FIG. 7c is a top view of a timing belt tensioner according to an embodiment of the present application; and

FIG. 8 is another schematic diagram of a planar structure illustrating part of the structure of a timing belt tensioner according to an embodiment of the present application.

### DETAILED DESCRIPTION

Technical solutions in the embodiments of the present application will be clearly and fully described below with reference to the accompanying drawings in the embodiments of the present application.

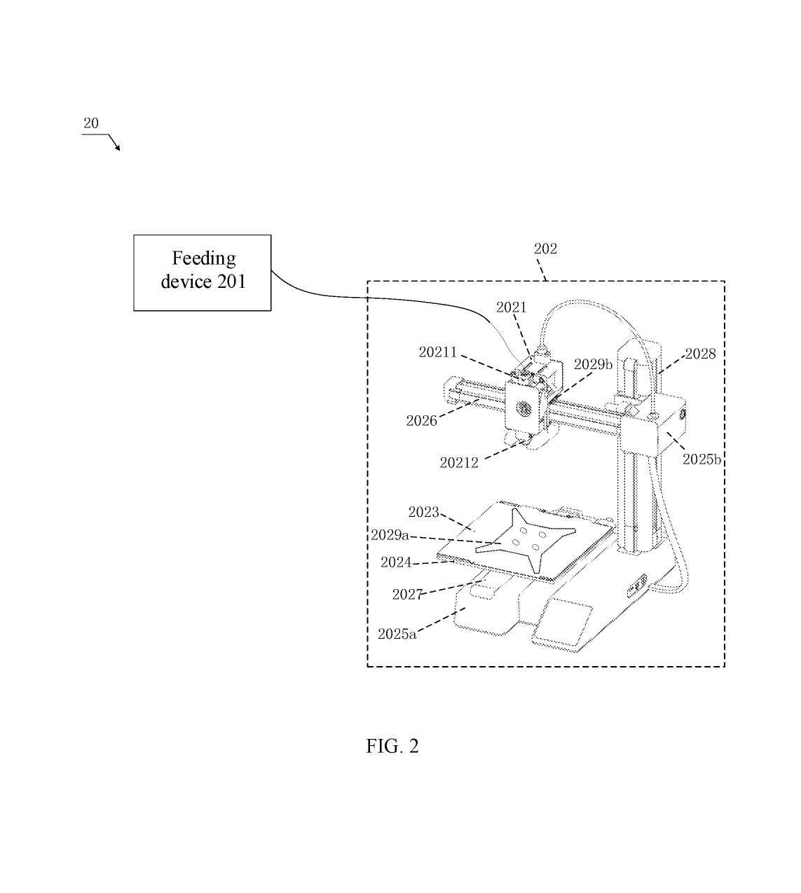

Referring to FIG. 2, FIG. 2 is a schematic diagram of a scenario of a 3D printing system according to an embodiment of the present application. As shown in FIG. 2, a 3D printing system 20 includes a feeding device 201 and a 3D printer 202 connected to the feeding device 201.

The feeding device 201 can hang a filament spool, and a printing material is wound around the filament spool. The feeding device 201 may provide the printing material to the 3D printer 202. Alternatively, the printing material may be rewound onto the filament spool through the feeding device 201. That is, the feeding device 201 can feed or retract materials. Illustratively, the feeding device 201 may also identify the material information of the printing material and send the material information of the printing material to the 3D printer 202.

The 3D printer 202 includes a print head 2021, where the print head 2021 includes a filament guide unit 20211, a nozzle 20212, and an extrusion assembly arranged between the filament guide unit 20211 and the nozzle 20212. During the feeding process of the feeding device 201, the printing material passes through the filament guide unit 20211 and enters the extrusion assembly, and the extrusion assembly provides the printing material to the nozzle 20212. During the retracting process of the feeding device 201, the 3D printer 202 cuts off the printing material in the print head 2021, and the extrusion assembly conveys the printing material to the feeding device 201.

In one embodiment, the 3D printer 202 may, for example, cut off the printing material between the extrusion assembly and the nozzle 20212, or cut off the printing material within the extrusion assembly. The position where the 3D printer cuts off the printing material is not limited in the present application.

Illustratively, the 3D printer 202 further includes a build plate 2023, a heatbed 2024, a base 2025a, and a sliding block 2029a. The heatbed 2024 is disposed on a side of the base 2025a facing the nozzle 20212, and the heatbed 2024 has a heating function. The build plate 2023 is arranged on a side of the heatbed 2024 facing the nozzle 20212, the heat of the heatbed 2024 can be conducted to the build plate 2023, and the nozzle 20212 can extrude a printing material in a molten state onto the build plate 2023. In one embodiment, the 3D printer 202 further includes a base 2025b and a sliding block 2029b.

In a specific implementation, the 3D printer may adjust the temperatures of the nozzle 20212 and the heatbed 2024. The 3D printer adjusts the temperature of the nozzle 20212 to heat the printing material to a molten state, and adjusts the temperature of the heatbed 2024 to adhere the printing material extruded from the nozzle 20212 to the build plate 2023. The print head 2021 is slidably connected to a first guide rail 2026, and the print head 2021 is movable along a length direction of the first guide rail 2026. That is, the displacement of the print head 2021 relative to the build plate 2023 along the length direction of the first guide rail 2026 is achieved. Moreover, the heatbed 2024 is slidably connected to a second guide rail 2027, and the heatbed 2024 moves along a length direction of the second guide rail 2027. That is, the displacement of the print head 2021 relative to the build plate 2023 along the length direction of the second guide rail 2027 is achieved. The length direction of the second guide rail 2027 is perpendicular to the length direction of the first guide rail 2026. Moreover, the first guide rail 2026 is slidably connected to a third guide rail 2028, and the 3D printer 202 can achieve the displacement of the print head 2021 relative to the build plate 2023 in a direction perpendicular to the length of the second guide rail 2027 and a direction perpendicular to the length of the first guide rail 2026 by moving the first guide rail 2026 along the third guide rail 2028. That is, the 3D printer 202 can implement three printing paths in three mutually perpendicular directions, thereby printing three-dimensional objects.

In some feasible embodiments, the base 2025b is provided with a drive wheel, and the print head 2021 is provided with a driven wheel, where a timing belt is wound around the drive wheel and the driven wheel, and the timing belt is provided with a sliding block connected to the print head 2021, such that the print head 2021 can be dragged to move relative to the build plate 2023 along the length direction of the first guide rail 2026. The timing belt is provided with a timing belt tensioner.

Alternatively, the base 2025a is provided with a drive wheel and a driven wheel, where a timing belt is wound around the drive wheel and the driven wheel, and the timing belt is provided with a sliding block connected to the heatbed 2024, such that the heatbed 2024 can be dragged to move along the length direction of the second guide rail 2027. The timing belt is provided with a timing belt tensioner.

In the timing belt tensioner provided in the present application, a tensioning block is specifically provided for the driven wheel, and the distance between the driven wheel and the drive wheel can be adjusted through the tensioning block, thereby adjusting the tension of the timing belt. Compared with using a tensioning wheel, the present application can complete the tensioning of the timing belt with a smaller space occupation.

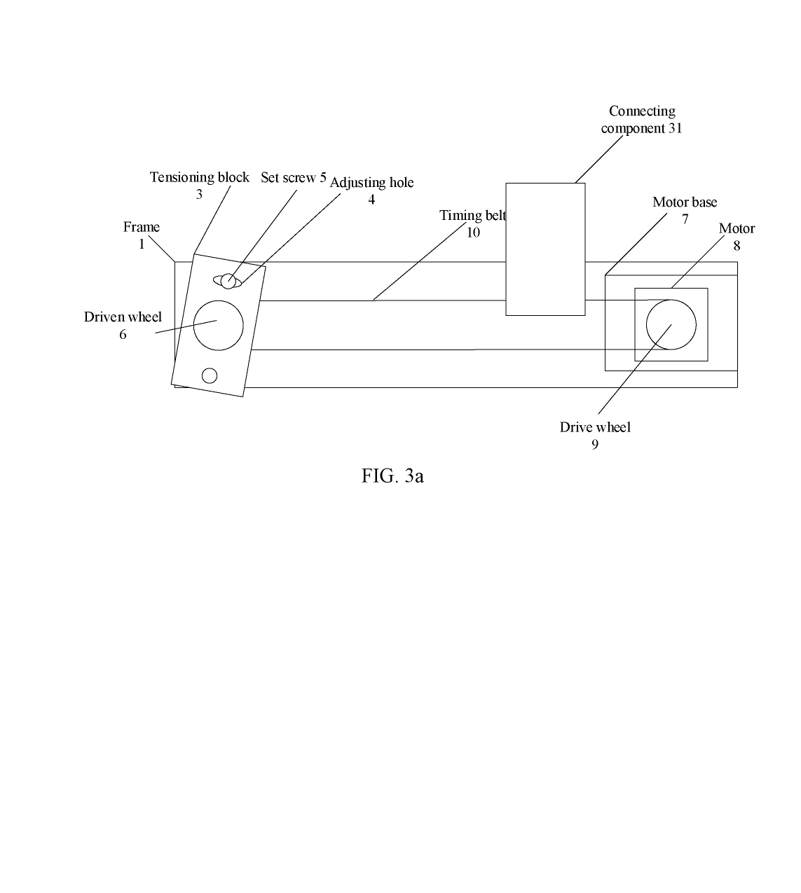

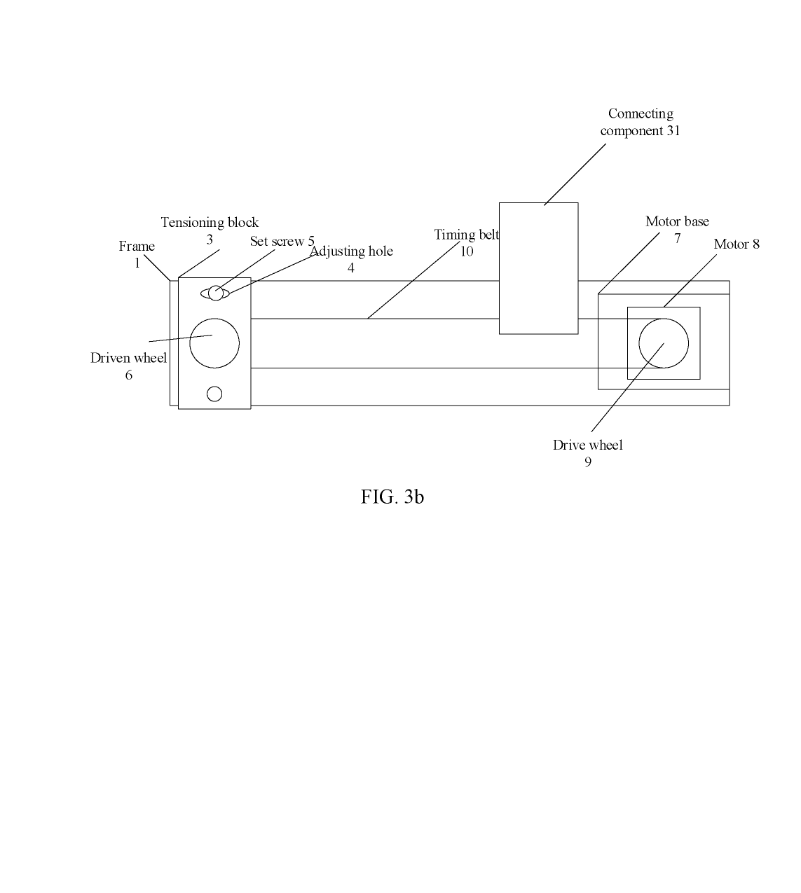

The structure of the timing belt tensioner will be described in detail below with reference to FIG. 3a to FIG. 8.

Referring to FIG. 3a, FIG. 3a is a schematic diagram of a planar structure of a timing belt tensioner according to an embodiment of the present application. The timing belt tensioner shown in FIG. 3a includes a frame 1, a tensioning block 3, a drive wheel 9, a driven wheel 6, and a motor 8.

The motor 8 is fixedly connected to the frame 1, a motor shaft of the motor 8 is connected to the drive wheel 9, and the drive wheel 9 and the driven wheel 6 are connected through a timing belt 10.

One end of the tensioning block 3 is fixedly connected to the frame 1, the other end of the tensioning block 3 is provided with an adjusting hole 4, and the adjusting hole 4 is configured to adjust the position of the tensioning block 3 relative to the frame 1.

In addition, at a position between the end of the tensioning block 3, fixedly connected to the frame 1, and the adjusting hole 4, the tensioning block is further connected to a driven shaft of the driven wheel 6, and the tensioning block 3 is configured to change the distance between the driven wheel 6 and the drive wheel 9 when the position of the tensioning block 3 relative to the frame 1 is different.

Illustratively, as shown in FIG. 3a, the frame 1 may be provided with a motor base 7, and the motor base 7 may be provided with a motor 8. A motor shaft of the motor 8 may be connected to the drive wheel 9 to drive the drive wheel 9 to rotate. The frame 1 may also be provided with a driven wheel 6 matching the drive wheel 9, the timing belt 10 is wound around the drive wheel 9 and the driven wheel 6, and the timing belt 10 is provided with a connecting component 31 for connecting to other components that need to move (such as a print head or a heatbed); In one embodiment, the connecting component 31 may be a sliding block.

In the embodiments of the present application, the timing belt 10 may be tensioned by changing the position of the driven wheel 6. Specifically, the position of the driven wheel 6 may be changed by adjusting the position of the tensioning block 3 connected to the driven shaft of the driven wheel 6.

One end of the tensioning block 3 may be fixed to the frame 1, and the tensioning block 3 may rotate around the fixed point. In this case, it may be understood that the fixed connection may be that relative positions of the two objects are fixed, but the two objects may rotate relative to each other. The other end of the tensioning block 3 may be provided with an adjusting hole 4 for adjusting the position of the tensioning block 3 relative to the frame 1. Specifically, when the timing belt 10 needs to be tensioned, the tensioning block 3 may be moved from the position shown in FIG. 3a to the position shown in FIG. 3b, and the driven wheel 6 is farther away from the drive wheel 8. At this time, the timing belt 10 is in a tension state. In order to maintain the tensioning of the timing belt, a connecting component, such as a set screw 5 in FIG. 3b, may be used. The set screw 5 passes through the adjusting hole 4 and is screwed into the frame 1, thereby fixing both ends of the tensioning block 3 to the frame 1, so as to prevent the tensioning block 3 from moving and causing the timing belt 10 to become loose again.

In one embodiment, the driven shaft of the driven wheel 6 is connected to the tensioning block 3 at any position between the end of the tensioning block, fixedly connected to the frame 1, and the adjusting hole 4. The specific position relationship between the driven wheel 6 and the tensioning block 3 is not limited in the embodiments of the present application.

By implementing the embodiments of the present application, the timing belt 10 can be tensioned by changing the position of the driven wheel 6. In addition, compared with the prior art in which a tensioning wheel is used for tensioning, the present application requires less space.

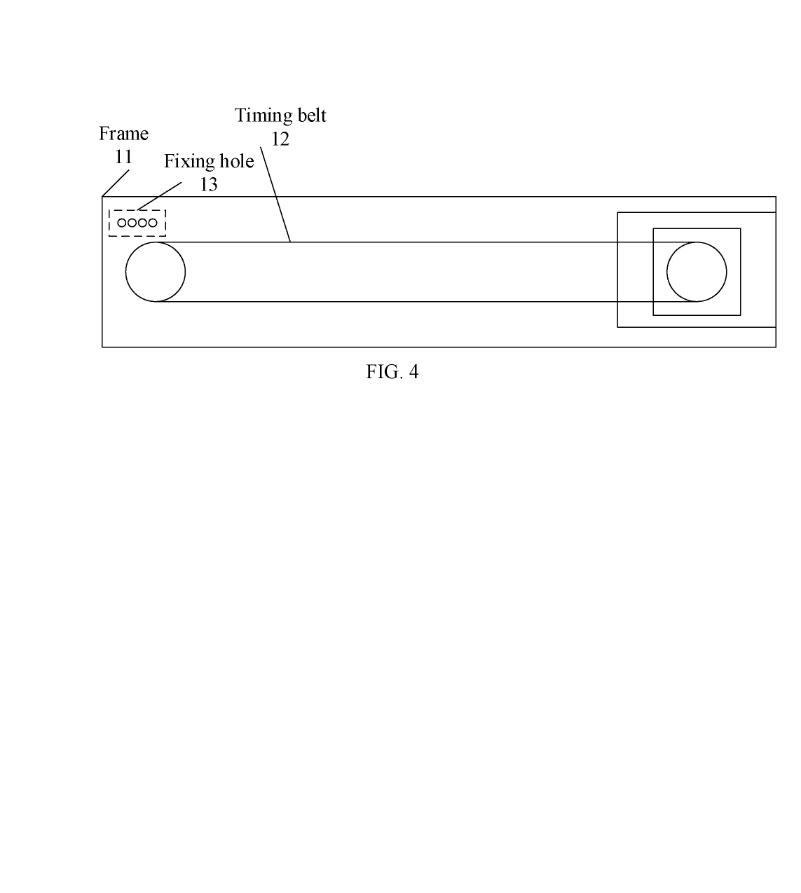

In some feasible embodiments, as shown in FIG. 4, the frame 11 is provided with a plurality of fixing holes 13 along a direction in which the timing belt 12 moves, and the plurality of fixing holes 13 are configured to fix the other end of the tensioning block after the position of the tensioning block relative to the frame 11 is adjusted to a preset position.

In one embodiment, a plurality of fixing holes 13 matching the adjusting hole may be provided on the frame 11 along the direction in which the timing belt 12 moves. After the tensioning block is adjusted to the preset position, the set screw may pass through the adjusting hole and be screwed into one of the plurality of fixing holes 13 to fix the other end of the tensioning block to the frame 11, thereby completing the tensioning of the timing belt 12. The number of the fixing holes and the distance between the fixing holes may be set according to actual situations. This is not limited in the embodiments of the present application.

In some feasible embodiments, the adjusting hole may be an arc-shaped hole. The arc-shaped hole may also be referred to as a waist-shaped hole.

In one embodiment, there is still a certain gap between the plurality of fixing holes. If there is no corresponding fixing hole at the preset position, the tension may be too large or insufficient. For this case, the adjusting hole may be configured as an arc-shaped hole to provide a preset movement space for the driven wheel. At the stage of adjusting the tension of the timing belt, a locking component may fix the tensioning block inside the waist-shaped hole, thereby fixing the position of the driven wheel and completing the adjustment of the tension of the timing belt.

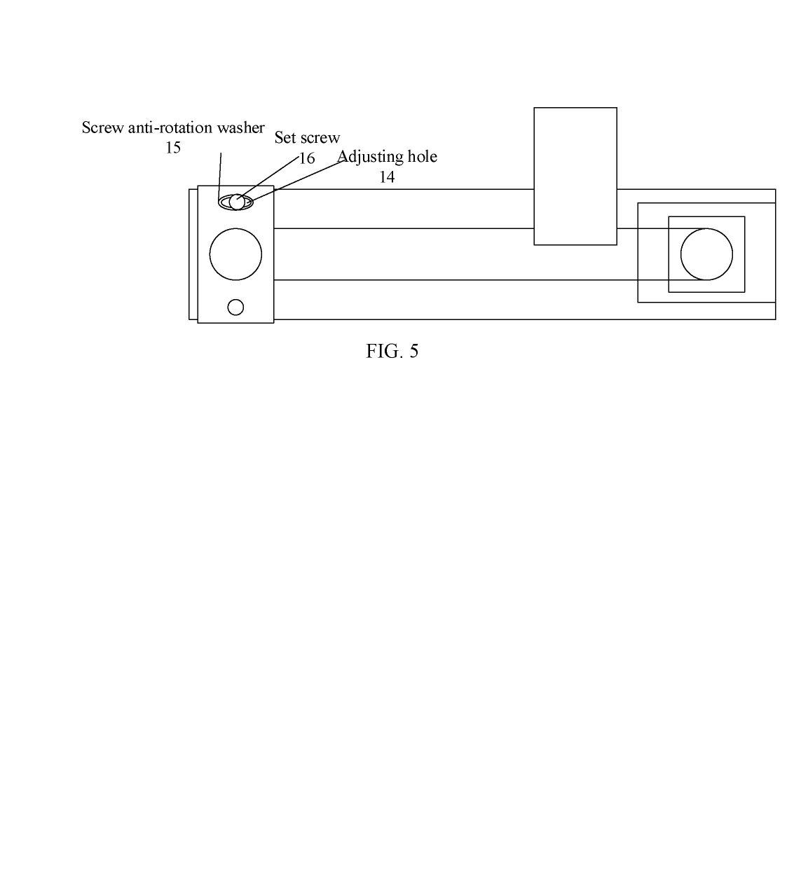

In some feasible embodiments, as shown in FIG. 5, the adjusting hole 14 may be provided with a screw anti-rotation washer 15. A set screw 16 may pass through the screw anti-rotation washer 15 and the adjusting hole 14 in sequence and then be screwed into the fixing hole arranged on the frame 1. By implementing the embodiments of the present application, the movement of the set screw in the adjusting hole, which causes the tensioning block to move and thus causes the tensioned timing belt to loosen, can be avoided, and the loosening of the set screw due to the vibration generated during the operation of the 3D printer can also be avoided.

In the embodiments of the present application, the screw anti-rotation washer may be a component that has a certain thickness and is provided with an anti-slip structure on a surface facing the screw head of the set screw, or may be of another screw anti-rotation structure. This is not limited in the embodiments of the present application.

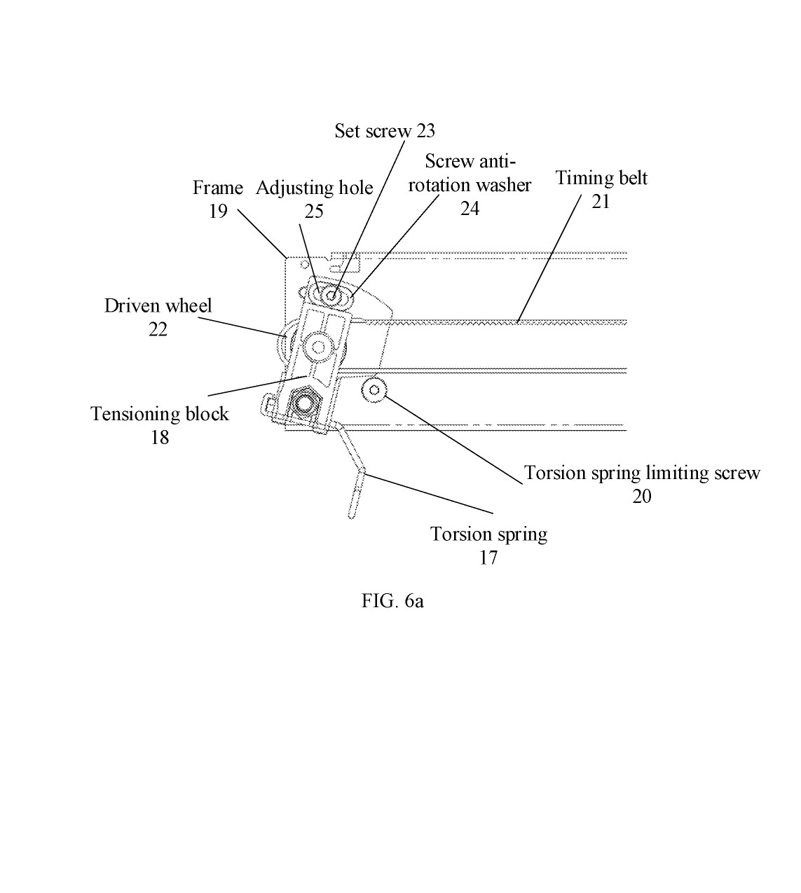

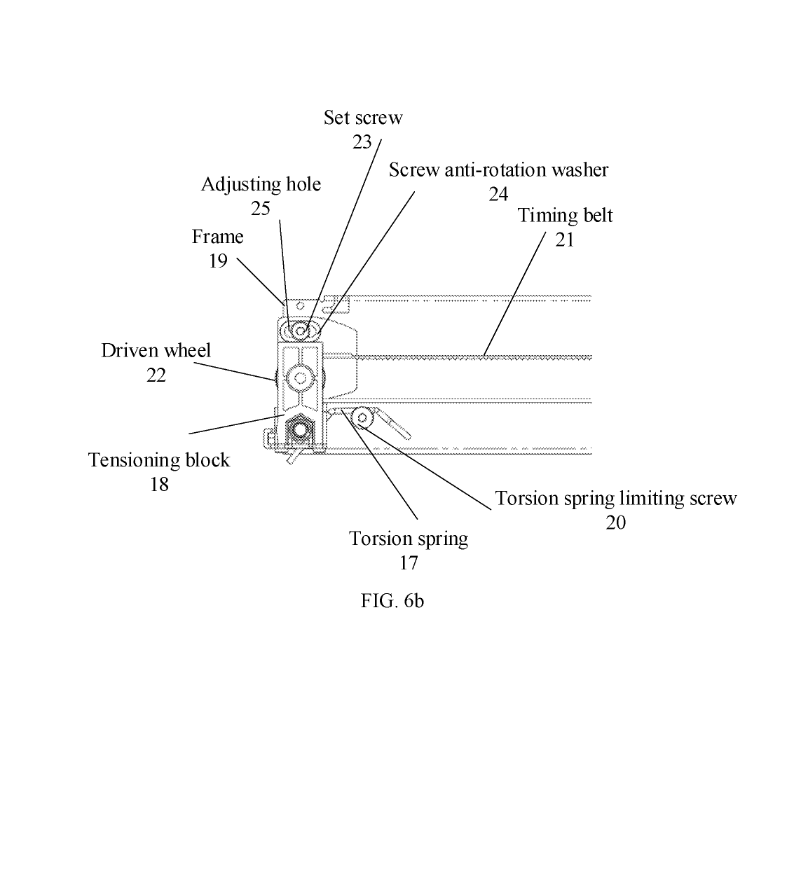

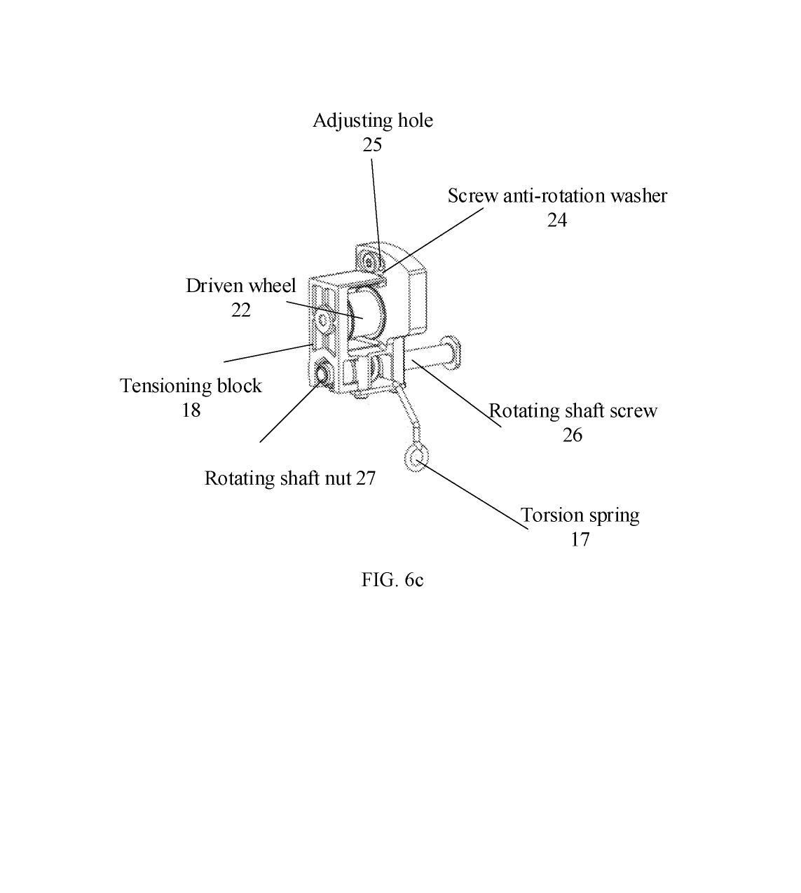

In some feasible embodiments, as shown in FIG. 6a, the timing belt tensioner may further include a torsion spring 17. One end of the torsion spring 17 is connected to a tensioning block 18, a frame 19 is provided with a torsion spring limiting screw 20, and the torsion spring limiting screw 20 is configured to suspend the other end of the torsion spring 17.

Although the timing belt can be tensioned by manually adjusting the position of the tensioning block, it is difficult to control the precision in manual adjustment. To improve the precision of tensioning, in the embodiments of the present application, a torsion spring 17 may be provided, and the torsion spring 17 may be a torsion spring that is designed in advance based on an actual scenario and can provide a certain elastic force. By twisting the torsion spring 17, a more precise force can be provided for the tensioning block 18 to complete the tensioning of a timing belt 21.

Specifically, one end of the torsion spring may be connected to one end or the other end of the tensioning block, or may be connected to a position between two ends of the tensioning block. This is not limited in the embodiments of the present application. As shown in FIG. 6a, the torsion spring 17 is connected to one end of the tensioning block 18.

When the torsion spring 17 is twisted, the tensioning block 18 may rotate. At this time, the position of the driven wheel 22 will change, and the driven wheel 22 undergone position change will apply tensioning force to the timing belt 21, thereby completing the tensioning of the timing belt 21.

The frame 19 may be provided with the torsion spring limiting screw 20. After the torsion spring 17 is operated, the other end of the torsion spring 17 may be hung on the torsion spring limiting screw 20, as shown in FIG. 6b, to further maintain the stability of the tensioning block 18 and prevent the tensioning block 18 from moving due to the elastic force of the timing belt 21.

While the other end of the torsion spring 17 is hung on the torsion spring limiting screw 20, a set screw 23 may pass through a screw anti-rotation washer 24 and an adjusting hole 25 in sequence and be screwed into the fixing hole on the frame 19.

In some feasible embodiments, one end of the tensioning block 18 is fixedly connected to the frame by using a fixed shaft, and one end of the torsion spring 17 is connected to the fixed shaft.

In one embodiment, one end of the torsion spring may extend into a groove corresponding to the fixed shaft, and the fixed shaft passes through the one end of the torsion spring. When the magnitude of the elastic force of the torsion spring is changed, the acting force is transmitted to the tensioning block through the fixed shaft, such that the tensioning block moves. In addition, because one end of the tensioning block is fixed, the tensioning block rotates around the fixed end under the action force. That is, by implementing the embodiments of the present application, the magnitude of the tension of the timing belt can be controlled by controlling the magnitude of the elastic force of the torsion spring. The magnitude of the elastic force of the torsion spring may be adjusted by using torsion springs with different elastic coefficients or by changing the position of the torsion spring limiting screw from which the other end of the torsion spring is suspended.

In some feasible embodiments, the timing belt tensioner further includes a rotating shaft screw and a rotating shaft nut, where one end of the rotating shaft screw is fixed to the frame of the 3D printer, and the other end of the rotating shaft screw passes through the first end of the tensioning block and protrudes from the surface of one end of the tensioning block; the rotating shaft nut is in threaded connection with a portion, protruding from the surface of the one end of the tensioning block, of the rotating shaft screw.

In the embodiments of the present application, one end of the rotating shaft screw may be fixed to the frame, and the other end of the rotating shaft screw may protrude from the surface of one end of the tensioning block and be in threaded connection with the rotating shaft nut. When the timing belt needs to be tensioned, the rotating shaft nut and the rotating shaft screw may be first unscrewed. After the adjustment is completed, the rotating shaft screw is screwed into the rotating shaft screw. By implementing the embodiments of the present application, the timing belt tensioner can be flexibly mounted and dismounted.

In some feasible embodiments, as shown in FIG. 6c, a rotating shaft screw 26 and a rotating shaft nut 27 may be specifically fixed to one end of the tensioning block 18, the other end of the tensioning block 18 is provided with an adjusting hole 25, and the adjusting hole 25 is provided with a screw anti-rotation washer 24. At a position between the end of the tensioning block 18, fixedly connected to the frame, and the adjusting hole 25, the tensioning block is further connected to a driven shaft of the driven wheel 22. The torsion spring 17 is specifically fixedly connected to the rotating shaft screw 26.

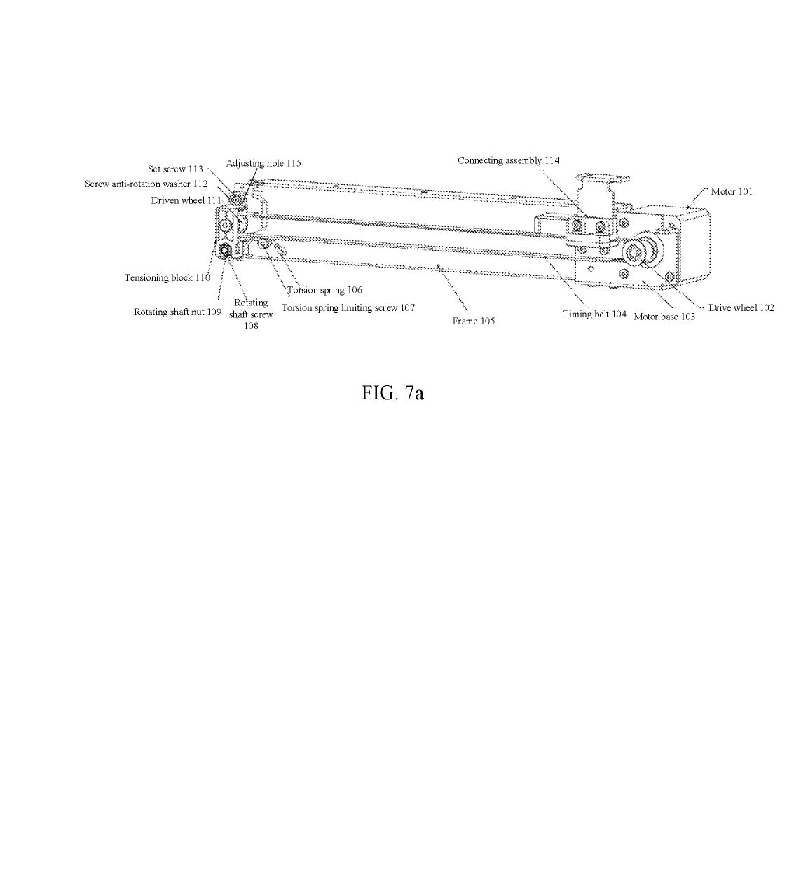

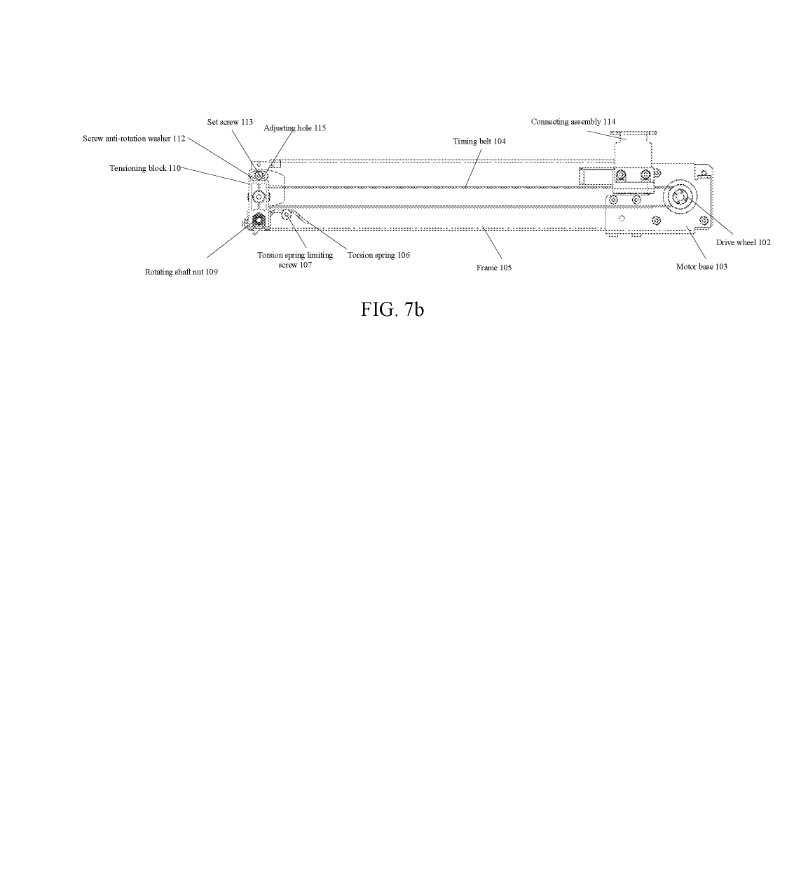

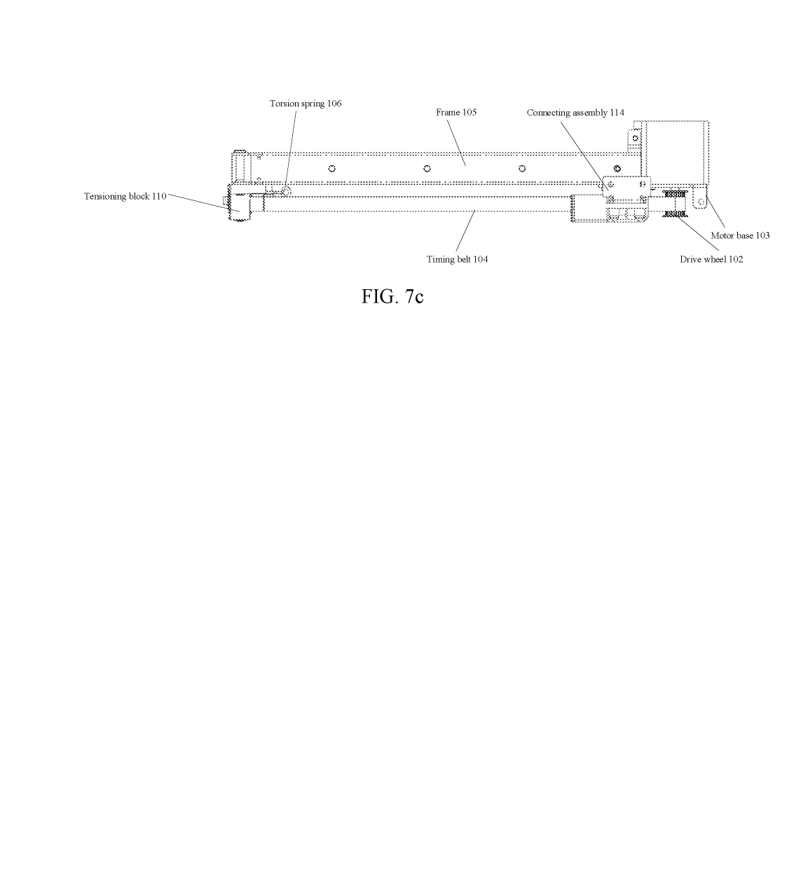

In some feasible embodiments, FIG. 7a is a schematic diagram of a three-dimensional structure of a timing belt tensioner according to an embodiment of the present application, FIG. 7b is a front view of a timing belt tensioner according to an embodiment of the present application, and FIG. 7c is a top view of a timing belt tensioner according to an embodiment of the present application.

A frame 105 may be provided with a motor base 103, and the motor base 103 may be provided with a motor 101. A motor shaft of the motor 101 may be connected to a drive wheel 102, and the other end of the frame 105 is provided with a driven wheel 111. The drive wheel 102 and the driven wheel 111 are connected through a timing belt 104, and the timing belt 104 is provided with a connecting assembly 114 for connecting to other components, such as a print head and a heatbed.

The driven wheel 111 is provided with a tensioning block 110. One end of the tensioning block 110 is fixed to the frame 105 through a rotating shaft screw 108 and a rotating shaft nut 109, and the other end of the tensioning block 110 is fixed to the frame 105 through an adjusting hole 115 and a set screw 113. The adjusting hole 115 is provided with a screw anti-rotation washer 112. The driven wheel 111 is located on the tensioning block 110 between the end at which the rotating shaft screw 108 is located and the end at which the adjusting hole 115 is located. The tensioning block 110 is further fixedly connected to one end of a torsion spring 106, and the other end of the torsion spring 106 is hung on a torsion spring limiting screw 107.

In some feasible embodiments, the timing belt is provided with a sliding block, and the sliding block is connected to a print head of the 3D printer.

In the embodiments of the present application, the timing belt tensioner described above may be configured to tension the timing belt corresponding to the print head. Specifically, the timing belt may be provided with a sliding block connected to the print head of the 3D printer. When the timing belt corresponding to the print head needs to be tensioned, the position of the tensioning block may be adjusted to change the position of the driven wheel corresponding to the print head, thereby completing the tensioning of the timing belt of the print head. By implementing the embodiments of the present application, the position of the driven wheel can be adjusted by moving the tensioning block, thereby tensioning the timing belt corresponding to the print head.

In some other feasible embodiments, the timing belt is provided with a sliding block, and the sliding block is connected to a heatbed of the 3D printer.

In the embodiments of the present application, the timing belt tensioner described above may be configured to tension the timing belt corresponding to the heatbed. Specifically, the timing belt may be provided with a sliding block connected to the heatbed of the 3D printer. When the timing belt corresponding to the heatbed needs to be tensioned, the position of the tensioning block may be adjusted to change the position of the driven wheel corresponding to the heatbed, thereby completing the tensioning of the timing belt of the heatbed. By implementing the embodiments of the present application, the position of the driven wheel can be adjusted by moving the tensioning block, thereby tensioning the timing belt corresponding to the heatbed.

In yet some other feasible embodiments, the timing belt may include a first timing belt and a second timing belt. The first timing belt is provided with a first sliding block, and the second timing belt is provided with a second sliding block. The first sliding block is connected to a print head of the 3D printer, and the second sliding block is connected to a heatbed of the 3D printer. By implementing the embodiments of the present application, the timing belts of the heatbed and the print head of the 3D printer can be tensioned with a small space occupation.

In some feasible embodiments, the timing belt tensioner may further include an accelerometer disposed on the sliding block. The accelerometer may be used to measure the acceleration of the sliding block to provide data support for the input shaping algorithm of the timing belt.

In some feasible embodiments, the timing belt tensioner may further include a coil and a resonance unit. The coil is connected to the resonance unit, the movement direction of the sliding block is perpendicular to a plane on which the coil is located, and the sliding block is within the magnetic field range of the coil.

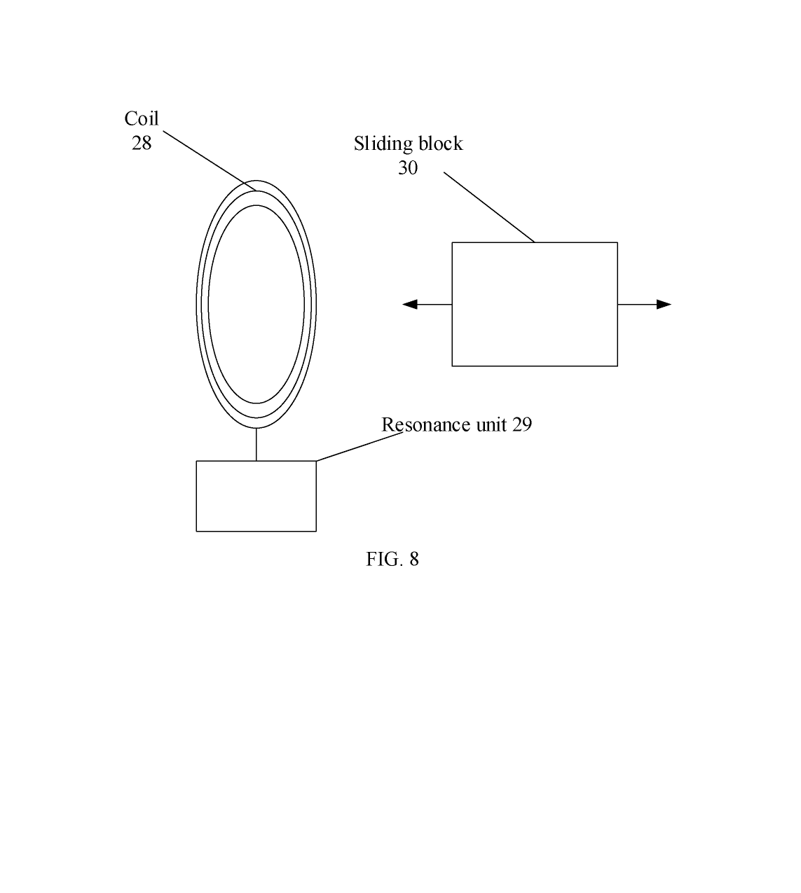

In the embodiments of the present application, to reduce the acceleration measurement costs of the sliding block, the acceleration may be measured by using the coil and the resonance unit. Specifically, as shown in FIG. 8, a coil 28 may be connected to the resonance unit 29, a plane on which the coil 28 is located may be perpendicular to the movement direction of a sliding block 30, and the sliding block 30 is within the magnetic field range of the coil 28. Therefore, when the sliding block 30 moves within the magnetic field range of the coil 28, the sliding block 30 affects the magnetic field of the coil 28. The acceleration of the sliding block 30 may be measured based on the change of the magnetic field of the coil 28.

Specific positions of the coil and the resonance unit may be set based on the actual situation. In one embodiment, the coil and the resonance unit may be disposed on a base corresponding to the sliding block. This is not limited in the embodiments of the present application.

In the embodiments of the present application, the position of the driven wheel is adjusted by adjusting the position of the tensioning block relative to the frame, so as to change the distance between the driven wheel and the drive wheel, thereby tensioning the timing belt wound around the drive wheel and the driven wheel. By implementing the embodiments of the present application, compared with the tensioning of the timing belt by using a tensioning wheel, the tensioning of the timing belt requires less space and the space compactness is good. In addition, the embodiments of the present application are applicable to a scenario in which there are only two rotating members, that is, timing belt tensioning involving one drive wheel and one driven wheel.

In one embodiment, at a position between the end connected to the frame and the other end, the tensioning block is further connected to a rotating shaft of the drive wheel. In this case, the position of the drive wheel is adjusted by adjusting the position of the tensioning block relative to the frame, so as to change the distance between the driven wheel and the drive wheel, thereby tensioning the timing belt wound around the drive wheel and the driven wheel.

With reference to the first aspect, in a first possible implementation, the frame is provided with a plurality of fixing holes along a direction in which the timing belt moves, and the plurality of fixing holes are configured to fix the other end of the tensioning block after the position of the tensioning block relative to the frame is adjusted to a preset position.

In the embodiments of the present application, the position of the fixing hole corresponds to the tensioning degree of the timing belt; that is, each fixing hole corresponds to different tensions of the timing belt. For example, when the other end of the tensioning block is fixed by the fixing hole closer to the drive wheel, the tension of the timing belt becomes smaller; that is, the timing belt is loosened; when the other end of the tensioning block is fixed by the fixing hole farther away from the drive wheel, the tension of the timing belt becomes larger; that is, the timing belt is tensioned. By implementing the embodiments of the present application, stepped adjustment of the tensioning of the timing belt is achieved through the fixing holes, making adjustment convenient and quick.

With reference to the first aspect or with reference to any one of the foregoing possible implementations of the first aspect, in a second possible implementation, the adjusting hole is an arc-shaped hole. The arc-shaped hole may also be referred to as a waist-shaped hole. That is, in the embodiments of the present application, a preset movement space may be provided for the driven wheel. At the stage of adjusting the tension of the timing belt, a locking component may fix the tensioning block inside the waist-shaped hole, thereby fixing the position of the driven wheel and completing the adjustment of the tension of the timing belt.

With reference to the first aspect or with reference to any one of the foregoing possible implementations of the first aspect, in a third possible implementation, the adjusting hole is provided with a screw anti-rotation washer.

In the embodiments of the present application, the screw anti-rotation washer may prevent the screw in the adjusting hole from loosening during running of the machine and thereby affecting the tensioning effect of the timing belt. That is, by implementing the embodiments of the present application, the reliability of tensioning the timing belt can be improved.

With reference to the first aspect or with reference to any one of the foregoing possible implementations of the first aspect, in a fourth possible implementation, the timing belt tensioner further includes:

a torsion spring, where one end of the torsion spring is connected to the tensioning block;

the frame is provided with a torsion spring limiting component, and the torsion spring limiting component is configured to suspend the other end of the torsion spring. Illustratively, the torsion spring limiting component may be a torsion spring limiting screw.

In the embodiments of the present application, a more precise force is applied to the tensioning block by using the torsion spring, such that the timing belt can be tensioned more precisely, thereby improving the accuracy of tensioning the timing belt.

With reference to the fourth possible implementation of the first aspect, in a fifth possible implementation, one end of the tensioning block described above is fixedly connected to the frame described above through a fixed shaft;

the one end of the torsion spring being connected to the tensioning block is specifically implemented as:

the one end of the torsion spring being connected to the fixed shaft.

In the embodiments of the present application, the magnitude of the tension of the timing belt can be controlled by controlling the magnitude of the elastic force of the torsion spring.

With reference to the first aspect or with reference to any one of the foregoing possible implementations of the first aspect, in a sixth possible implementation, the timing belt tensioner further includes a rotating shaft screw and a rotating shaft nut;

the one end of the tensioning block being fixedly connected to the frame includes:

one end of the rotating shaft screw being fixed to the frame of the 3D printer, and the other end of the rotating shaft screw passing through a first end of the tensioning block and protruding from a surface of the first end of the tensioning block;

the rotating shaft nut is in threaded connection with a portion, protruding from the surface of the first end of the tensioning block, of the rotating shaft screw.

In the embodiments of the present application, the timing belt tensioner can be flexibly mounted and dismounted.

With reference to the first aspect or with reference to any one of the foregoing possible implementations of the first aspect, in a seventh possible implementation, the timing belt is provided with a sliding block connected to a print head of the 3D printer.

In the embodiments of the present application, the timing belt for moving the print head can be tensioned based on a smaller space.

With reference to the first aspect or with reference to the second to sixth possible implementations of the first aspect, in an eighth possible implementation, the timing belt is provided with a sliding block connected to a heatbed of the 3D printer.

In the embodiments of the present application, the timing belt for moving the heatbed can be tensioned based on a smaller space.

With reference to the first aspect or with reference to the seventh to eighth possible implementations of the first aspect, in a ninth possible implementation, the timing belt is provided with a sliding block, and the sliding block is provided with an accelerometer.

In the embodiments of the present application, the fixed frequency of the sliding block may be measured based on the accelerometer.

With reference to the first aspect or with reference to the seventh to eighth possible implementations of the first aspect, in a tenth possible implementation, the timing belt is provided with a sliding block, and the timing belt tensioner further includes a coil and a resonance unit, where the coil is connected to the resonance unit, the movement direction of the sliding block is perpendicular to a plane on which the coil is located, and the sliding block is within the magnetic field range of the coil.

In the embodiments of the present application, the fixed frequency of the sliding block may be measured in a low-cost manner.

It should be noted that the terms “first” and “second” described above are used for descriptive purposes only and are not to be construed as indicating or implying relative importance.

The above descriptions are specific embodiments of the present application. However, the protection scope of the present application is not limited to this. Any variations or substitutions that those skilled in the art can easily think of within the technical scope disclosed in the present application should be included within the protection scope of the present application. Therefore, the protection scope of the present application should be subject to the protection scope defined by the claims.

1. A timing belt tensioner for a 3D printer, comprising:
a frame, a tensioning block, and only two rotating members, wherein the two rotating members comprise a first rotating member and a second rotating member;
the first rotating member and the second rotating member are connected by a timing belt;
a first end of the tensioning block is connected to the frame at a connection point, and a second end of the tensioning block is pivotable relative to the connection point;
at a position between the first end and the second end, the tensioning block is further connected to a rotating shaft of the first rotating member.

2. The timing belt tensioner according to claim 1, further comprising:
a motor connected to the frame, the motor having a motor shaft;
wherein:
the motor shaft is connected to the first rotating member, the first rotating member being a drive wheel and the second rotating member being a driven wheel; or
the motor shaft is connected to the second rotating member, the second rotating member being a drive wheel, and the first rotating member being a driven wheel.

3. The timing belt tensioner according to claim 1, further comprising:
a torsion spring, wherein one end of the torsion spring is connected to the tensioning block;
the frame is provided with a torsion spring limiting component, and the torsion spring limiting component is configured to be connected to the other end of the torsion spring.

4. The timing belt tensioner according to claim 3, wherein the first end of the tensioning block is connected to the frame through a fixed shaft;
the one end of the torsion spring being connected to the tensioning block comprises:
the one end of the torsion spring being connected to the fixed shaft.

5. The timing belt tensioner according to claim 1, wherein the second end of the tensioning block is provided with an adjusting hole, and a center of the adjusting hole is located on a same straight line as the first end, connected to the frame, of the tensioning block.

6. The timing belt tensioner according to claim 1, wherein the frame is provided with a plurality of fixing holes along a direction in which the timing belt moves.

7. The timing belt tensioner according to claim 5, wherein
the adjusting hole is an arc-shaped hole.

8. The timing belt tensioner according to claim 7, wherein
the adjusting hole is provided with a screw anti-rotation washer.

9. The timing belt tensioner according to claim 1, further comprising a rotating shaft screw and a rotating shaft nut,
wherein the first end of the tensioning block being connected to the frame comprises:
one end of the rotating shaft screw being fixed to the frame, and the other end of the rotating shaft screw passing through the first end of the tensioning block and protruding from a surface of the first end of the tensioning block;
the rotating shaft nut is in threaded connection with a portion, protruding from the surface of the first end of the tensioning block, of the rotating shaft screw.

10. The timing belt tensioner according to claim 1, wherein the timing belt is provided with a sliding block connected to a print head of the 3D printer.

11. The timing belt tensioner according to claim 1, wherein the timing belt is provided with a sliding block connected to a heatbed of the 3D printer.

12. A 3D printer, comprising:
a timing belt; and
a timing belt tensioner, comprising a frame, a tensioning block, and only two rotating members, wherein the two rotating members comprise a first rotating member and a second rotating member;
the first rotating member and the second rotating member are connected through the timing belt;
one end of the tensioning block is connected to the frame, and the other end of the tensioning block is rotatable about the end connected to the frame;
at a position between the end connected to the frame and the other end, the tensioning block is further connected to a rotating shaft of the first rotating member.

13. The 3D printer according to claim 12, comprising:
a motor connected to the frame, the motor having a motor shaft;
wherein:
the motor shaft is connected to the first rotating member, the first rotating member being a drive wheel and the second rotating member being a driven wheel; or
the motor shaft is connected to the second rotating member, the second rotating member being a drive wheel, and the first rotating member being a driven wheel.

14. The 3D printer according to claim 12, wherein the timing belt tensioner further comprising:
a torsion spring, wherein one end of the torsion spring is connected to the tensioning block;
the frame is provided with a torsion spring limiting component, and the torsion spring limiting component is configured to be connected to the other end of the torsion spring.

15. The 3D printer according to claim 14, wherein the first end of the tensioning block is connected to the frame through a fixed shaft;
the one end of the torsion spring being connected to the tensioning block comprises:
the one end of the torsion spring being connected to the fixed shaft.

16. The 3D printer according to claim 12, wherein the second end of the tensioning block is provided with an adjusting hole, and a center of the adjusting hole is located on a same straight line as the one end, connected to the frame, of the tensioning block.

17. The 3D printer according to claim 12, wherein the frame is provided with a plurality of fixing holes along a direction in which the timing belt moves.

18. The 3D printer according to claim 12, further comprising a print head, wherein the timing belt is provided with a sliding block connected to the print head.

19. The 3D printer according to claim 12, further comprising a heatbed, wherein the timing belt is provided with a sliding block connected to the heatbed.

20. A 3D printing system, comprising:
a feeding device; and
a 3D printer, comprising:
a timing belt; and
a timing belt tensioner, comprising a frame, a tensioning block, and only two rotating members, wherein the two rotating members comprise a first rotating member and a second rotating member;
the first rotating member and the second rotating member are connected by the timing belt;
a first end of the tensioning block is connected to the frame at a connection point, and a second end of the tensioning block is pivotable relative to the connection point;
at a position between the first end and the second, the tensioning block is further connected to a rotating shaft of the first rotating member;
wherein the feeding device is connected to the 3D printer.
